(19) United States
(12) Patent Application Publication
(10) Pub. No.: US 2022/0084414 A1
(43) Pub. Date: Mar. 17, 2022

(54) AIRCRAFT OPERATION PATH PLANNING METHOD, CONTROL DEVICE AND CONTROL EQUIPMENT

(71) Applicant: SUZHOU EAVISION ROBOTIC TECHNOLOGIES CO., LTD., Suzhou, Jiangsu (CN)

(72) Inventors: Jihua HUANG, Suzhou (CN); Han Shue TAN, Suzhou (CN); Xuesong DONG, Suzhou (CN)

(73) Assignee: SUZHOU EAVISION ROBOTIC TECHNOLOGIES CO., LTD., Suzhou, Jiangsu (CN)

(21) Appl. No.: 17/420,599

(22) PCT Filed: Nov. 29, 2019
(86) PCT No.: PCT/CN2019/122130

§ 371 Date: Jul. 2, 2021

(30) Foreign Application Priority Data
Jan. 8, 2019 (CN) 201910015633.2

(51) Int. Cl. G08G 5/00; B64C 39/02

(52) U.S. Cl. CPC G08G 5/003; B64C 2201/12; B64C 39/024; G08G 5/0065

(57) ABSTRACT

The application relates to an aircraft operation path planning method and a control device and a control equipment. The method comprises the following steps: obtaining a docking point, an operation point, and a safe point, wherein no obstacle exists within a safe distance range of the safe point (S100); planning a first path between the docking point and the safe point and a second path between the safe point and the operation point, so that the path between the docking point and the operation point passes through the safe point in a smooth transition manner (S200).

### CROSS-REFERENCE TO RELATED APPLICATION

This disclosure claims priority to the Chinese Patent Application No. 201910015633.2, filed to the China National Intellectual Property Administration on Jan. 8, 2019, the entire content of which is incorporated herein by reference.

### FIELD OF THE PRESENT DISCLOSURE

The application belongs to the field of aircraft, for example, relating to an aircraft operation path planning method, a control device, and a control equipment.

### BACKGROUND OF THE PRESENT DISCLOSURE

When an aircraft enters an operation area to operate according to a planned route, the aircraft usually flies from a take-off point directly to a first waypoint of the operation route along a straight line. If obstacles such as trees, wire poles, and the like exist on the boundary of the area at the time, and if the unmanned aerial vehicle does not have an autonomous obstacle avoidance function, or the autonomous obstacle avoidance function is not good in effect, the aircraft can easily collide with obstacles on the boundary of the area. Even if the aircraft has a good autonomous obstacle avoidance function, it may also require a long time and great power consumption to execute the autonomous obstacle avoidance function to reach the interior of the operation area. It is the same as for the landing site.

In view of this, it is an issue to be studied by the present application to propose a more efficient and safer path planning method for aircraft operation.

### SUMMARY OF THE PRESENT DISCLOSURE

The application provides an aircraft operation path planning method, a control device, and control equipment, and aims to solve the problem that an aircraft cannot safely and rapidly enter an operation area.

The application provides an aircraft operation path planning method, including steps as follows:

obtaining a docking point, an operation point, and a safe point, wherein no obstacle exists within a safe distance range of the safe point; and

planning a first path between the docking point and the safe point and a second path between the safe point and the operation point, so that a path between the docking point and the operation point passes through the safe point in a smooth transition manner.

The method further includes:

obtaining a first auxiliary point on the first path, wherein a distance from the first auxiliary point to the safe point is less than or equal to the safe distance and less than or equal to the distance from the safe point to the operation point on the second path, and planning an arc close to the safe point as a third path by taking the first auxiliary point as a tangent point and taking the first path and the second path as tangents, so that the first path and the second path transit through the third path.

The docking point is located outside an operation area, the safe point is located inside the operation area, the operation area is surrounded by several boundaries, and a distance from the first auxiliary point to the safe point is less than or equal to a distance from the safe point to a point where the first path intersects with the boundary.

The third path is obtained in at least two ways below:

obtaining a second auxiliary point on the second path, wherein the distance from the second auxiliary point to the safe point is the distance from the first auxiliary point to the safe point, and planning an arc close to the safe point as the third path by taking the first auxiliary point and the second auxiliary point as tangent points; or

obtaining an angle bisector of the first path and the second path, obtaining a circle center which is an intersection point of a vertical line taking the first auxiliary point on the first path as a foot and the angle bisector, and planning an arc close to the safe point as the third path by using the circle center and taking a vertical distance from the circle center to the first auxiliary point as a radius.

A radius of the third path is r=s*tan(θ/2), wherein s is a distance from the first auxiliary point to the safe point on the first path, θ is an included angle between the first path and the second path, and the radius of the third path is r≥1 m.

Obtaining a distance from the docking point to the first auxiliary point on the first path as a first speed limiting distance, and obtaining a distance from the operation point on the second path to a tangent point of the third path and the second path as a second speed limiting distance, wherein the first speed limiting distance and the second speed limiting distance are greater than or equal to

$$\frac{{w}^{2} {r}^{2}}{2 a} ,$$

wherein ω is an angular speed known to travel through the third path, a is a maximum threshold of known travelling accelerated speed, and r is the radius of the third path.

The docking point is a take-off point or a landing point.

The operation point comprises any point in an operation task path.

By smooth transition is meant that there is no turning point when the path passes through the safe point.

The application also provides a control device, including:

an obtaining module for obtaining a docking point, an operation point, and a safe point, wherein no obstacle exists within a safe distance range of the safe point; and

a planning module for planning a first path between the docking point and the safe point and a second path between the safe point and the operation point, so that a path between the docking point and the safe point passes through the safe point in a smooth transition manner.

The control device further comprises: the planning module also obtaining a first auxiliary point on the first path, wherein a distance from the first auxiliary point to the safe point is less than or equal to the safe distance and less than or equal to the distance from the safe point to the operation point on the second path, and planning an arc close to the safe point as a third path by taking the first auxiliary point as a tangent point and taking the first path and the second path as tangents, so that the first path and the second path transit through the third path.

The application also provides a control equipment, which is arranged on an aircraft or a mobile terminal, including:

one or more processors;

a memory; and

one or more application programs, wherein the one or more application programs are stored in the memory and configured to be executed by the one or more processors, and the one or more programs are configured to execute the steps of the aircraft path planning method.

The docking point may also be a location where the user places an unmanned aerial vehicle, or a planned starting point or landing point.

The advantages of the present application are as follows.

(1) According to the application, the flight path of the unmanned aerial vehicle aircraft is transited through the safe point such that the unmanned aerial vehicle can safely enter or leave the operation area.

(2) According to the application, the aircraft flies according to a path transited through a third path without staying at the safe point such that the flight speed of the aircraft is improved, and the operation efficiency is improved.

(3) According to the application, the aircraft can be prevented from stopping at the safe point such that the damage to an operation target is avoided.

In summary, the aircraft according to the application enters or leaves the operation area through the safe point without needing to stay at the safe point. The aircraft flies along an arc, changes the heading while flying along the arc such that the heading is consistent with the tangential direction of the arc, and then flies to the operation point. According to the application, on one hand, the operation efficiency can be improved, and on the other hand, no damage will be caused to the operation target below the safe point.

### BRIEF DESCRIPTION OF THE DRAWINGS

FIG. 1 is a schematic diagram of a path planning method according to alternative embodiment 1 of the present application.

FIG. 2 is a schematic diagram of a path planning method according to alternative embodiment 2 of the present application.

FIG. 3 is a schematic diagram of a path planning method according to alternative embodiment 3 of the present application.

FIG. 4 is a block diagram of a control device of an alternative embodiment of the present application.

### DESCRIPTION OF THE EMBODIMENTS

The present application is further described below with reference to the accompanying drawings and embodiments as follows.

The application discloses an aircraft operation path planning method to solve the problem in the related art that an aircraft cannot safely and quickly go through an operation boundary. The specific method includes the following steps.

S100: obtaining a docking point and an operation point, and a safe point, wherein no obstacle exists within a safe distance range of the safe point, that is, in a range smaller than or equal to the safe distance, no obstacle affecting the flight exists such that the safe flight of the aircraft is ensured. The safe distance can be 2 m, 2.5 m, 3 m, 3.5 m, 4 m, and the like, which may be set in accordance with inherent parameters of the aircraft and/or environmental conditions and the like, and is not limited herein. The docking point is a take-off point or a landing point, can be a point determined automatically or manually during a flight, or can be a point when the aircraft is static, and is not limited herein. The docking point and safe point can be located in the operation area, or outside the operation area, or on the operation area, and is not limited herein. The operation point includes any point in the operation task path, and can be automatically or manually planned and confirmed in real time or in advance according to different operation tasks. When the operation area is large and continuous operation is needed, the operation point can be the end point of the last operation, and therefore path planning can be realized automatically and quickly. In general, it cannot be ensured that an obstacle does not exist on a path between a docking point and an operation point. Therefore, a safe point is arranged. The safe point does not have an obstacle in a safe range, that is, an obstacle affecting flight safety such as a wire pole, a hillock, a branch and the like does not exist. As long as within the safe distance of the safe point, the aircraft can safely penetrate through to fly or penetrate through an operation boundary and the like without encountering obstacles such that the planned path is safer.

S200: planning a first path between the docking point and the safe point and a second path between the safe point and an operation point, so that a path between the docking point and the operation point passes through the safe point in a smooth transition manner.

In some embodiments, a path is planned among the three points of docking point A, safe point B, and operation point C to form a straight line flight track, and a smooth transition near the safe point enables the planned path to have no turning point. When the aircraft flies from any docking point A outside the operation area to the vicinity of the safe point B along a straight line, there are no obstacles within the safe distance range of the safe point B. The aircraft then flies from the vicinity of safe point B to any operation point C on the planned path along a straight line. When the aircraft flies from A to B, the speed of the aircraft accelerates and decelerates to zero to reach B, and when the aircraft flies from B to C, the speed of the aircraft accelerates from zero. The planned path passes through the safe point between the docking point and the operation point such that the unmanned aerial vehicle flies between the docking point and the operation point along a first path and a second path (from the first path to the second path in sequence or from the second path to the first path in sequence), and the autonomous and safe going through the operation boundary can be realized. It should be noted that obstacle information in a pre-set path may also be included in the planned path to ensure that the planned air route is completely free of obstacles and the flight safety is further enhanced.

In some embodiments, when the docking point is located outside the operation area and the operation area is surrounded by several boundaries, the safe point B can also be located in the operation area and the distance between the safe point B and any boundary is greater than or equal to a preset threshold such that the position of the safe point can be ensured not to contact the operation boundary, and the aircraft can be ensured to safely fly from the docking point to the safe point in a path without touching an unknown operation boundary which may result in an unknown collision accident. In some other embodiments, when the docking point is located in the operation area, the safe point is also located in the operation area, and the distance between the safe point and any boundary is greater than or equal to a preset threshold. The aircraft can also be ensured to safely fly from the docking point to the safe point and then from the safe point to the operation point.

When the safe point is located in the operation area, the distance between the safe point and any boundary can be greater than or equal to a preset threshold, and it can be understood that the distance between the safe point and any boundary of the operation area is greater than or equal to a first threshold. In general, the first threshold includes 1.5 m, 2 m, 3 m, 3.5 m, or 4 m, etc. and can be set according to the inherent parameters of the aircraft itself, provided that it is ensured that half of the fuselage of the aircraft does not collide with the area boundary, which will not be limited herein. The safe point may also be spaced from the nearest boundary of the docking point by a distance greater than or equal to a second threshold which includes 2.5 m, 3 m, 3.5 m, or 4 m, etc. provided that the aircraft is ensured to go safely through the operation boundary and may change direction appropriately, which will not be limited herein. Therefore, under the condition that the aircraft can be ensured to safely enter the area boundary from the docking point, the safe point is a point that is arranged in the operation area at a certain distance from the boundary of the operation area and an obstacle. When the path between the docking point and the safe point has no obstacles, the aircraft safely goes through the operation boundary on the flight path between the docking point and the safe point, and does not collide with any other boundary. Meanwhile, since the safe point is located within the operation area, it is possible to safely fly from the safe point to any one of the operation points within the operation area. The safe point can be calculated in real time according to the docking point, the boundary of the operation area and the obstacle information, and the safety of going through the boundary of the operation area is ensured.

In some embodiments, the aircraft safely flies on a path through the safe point such that the aircraft can safely and quickly reach the operation point from the docking point through the safe point. The following steps are further included.

S300: obtaining a first auxiliary point on a first path, wherein the distance from the first auxiliary point to the safe point is less than or equal to the safe distance and less than or equal to the distance from the safe point to the operation point on a second path. Taking the first auxiliary point as a tangent point, an arc close to the safe point is planned as a third path by taking the first path and the second path as tangents, and the first path and the second path are enabled to smoothly transition through the third path. At this time, the path between the docking point and the safe point still passes through the safe point, and the difference is that the planned path is close to the safe point and deviates from the safe point such that no turning point exists when the path passes through the safe point.

If the planned path has no smooth transition at the safe point B, the aircraft needs to be rotated at the safe point B so that the heading direction of the aircraft changes from direction A to B to the direction B to C. It has a pause time of a few seconds at the safe point B, that is, it consumes such time for each take-off and landing. When the operation is carried out on large field, due to the limitation of a power supply, several times of operation can be carried out such that more time can be spent at the safe point, greatly reducing the timeliness of the operation. At the same time, when aiming at the same operation area, the safe point is generally fixed, and if the suspension time on the same safe point is too long, the downward pressure wind field formed by the high-speed rotation of the blades of the aircraft can influence the growth of the operation target below the blades and even damage the operation target. In short, the aircraft flies from the take-off point to the middle of the operation point, stays at the safe point, rotates at the safe point to change the heading direction of the aircraft to fly to the operation point, which affects the efficiency, and may cause damage to the operation target below the safe point due to repeated stays. Therefore, the third path is designed to realize the transition between the first path and the second path such that the aircraft can realize rapid flight operation on the planned path, the operation efficiency is improved, and no harm will be caused to the operation target.

It is to be noted that regardless of the positional relationship of the safe point, the docking point, and the operation area, as long as there are no obstacles within the safe distance range, and the distance from the first auxiliary point to the safe point is less than or equal to the safe distance and less than or equal to the distance from the safe point to the operation point on the second path, the third path can be ensured to be in an unobstructed zone, and the safe flight on the path from the docking point to the operation point can be realized. On one hand, the distance from the first auxiliary point to the safe point is less than or equal to the safe distance so as to ensure that the third path is within the safe distance without obstacles. On the other hand, the distance from the first auxiliary point to the safe point is less than or equal to the distance from the safe point to the operation point on the second path such that the third path and the second path can be effectively transited, the distance from the safe point to the operation point is prevented from being too short to realize the transition, and the effectiveness of path planning is ensured.

In some embodiments, the docking point is located outside the operation area, the safe point is located inside the operation area, and the distance from the first auxiliary point to the safe point is less than or equal to the distance from the safe point to the point where the first path intersects with the boundary such that the third path can be located inside the operation area without intersecting with the operation boundary, thereby improving the safety of the flight transition. When the docking point is located outside the operation area and the safe point is located inside the operation area, the first path between the docking point and the safe point must be intersected with the operation boundary. At the time, in order to improve flight safety, the first auxiliary point can be located inside the operation area such that unknown potential safety hazards caused by the intersection of the third path with the operation boundary are prevented.

The third path is obtained in at least two ways as follows: obtaining a second auxiliary point on a second path, wherein the distance from the safe point to the second auxiliary point is the distance from the first auxiliary point to the safe point, taking the first auxiliary point and the second auxiliary point as tangent points, and planning an arc close to the safe point as a third path; or obtaining an angle bisector of the first path and the second path, obtaining a circle center which is an intersection point of a vertical line taking the first auxiliary point on the first path as a foot and the angle bisector, taking a vertical distance from the circle center to the first auxiliary point as a radius, and planning an arc close to the safe point as a third path. The method of determining the third path is not so limited as long as the third path is ensured to be within the operation area.

The radius of the third path is r=s*tan(θ/2), wherein s is the distance from the first auxiliary point to the safe point on the first path, θ is the angle between the first path and the second path, and the radius of the third path is r≥1 m. r can also be ≥1.5 m or ≥2 m or ≥2.5 m or ≥3 m, etc., and the user can set r according to operational needs or environmental needs or aircraft performance, which will not be limited herein.

Obtaining a distance from a docking point to the first auxiliary point on the first path as a first speed limiting distance, and obtaining a distance from the operation point on the second path to a tangent point of the third path and the second path as a second speed limiting distance, wherein the first speed limiting distance and the second speed limiting distance are greater than or equal to

$$\frac{{w}^{2} {r}^{2}}{2 a} ,$$

wherein ω is an angular speed known to travel through the third path, and a is a maximum threshold of known travelling accelerated speed. Since a general aircraft has maximum accelerated speed, it is necessary to limit the first speed limiting distance and/or the second speed limiting distance so that the first speed limiting distance and/or the second speed limiting distance cannot be too short to achieve acceleration or deceleration.

According to the operation path planning method, the aircraft flies along the first path, the third path and the second path between the docking point and the operation point to realize rapid flight. No stay at the safe point is needed, and no harm is caused to the operation target. It should be noted that the aircraft may fly sequentially along the first path, the third path, and the second path from the docking point to the operation point, or may fly sequentially along the second path, the third path, and the first path from the operation point to the docking point. It may be adjusted according to take-off or landing, so long as a transition between the first path and the second path through the third path is ensured, which will not be limited herein.

The operation point can also be an end point in a previous operation task path, the end point in the previous operation task path being defined as a second operation point. The path is re-planned according to the docking point, the safe point and the second operation point, and the aircraft flies from the new first path, third path, and second path to the second operation point to realize continuous operation.

Referring to FIG. 4, the application also provides a control device, including:

an obtaining module used for obtaining a docking point, an operation point, and a safe point, wherein no obstacle exists in the safe distance range around the safe point.

The safe point can be acquired according to a pre-stored obstacle, or when the docking point is located outside the operation area, the safe point inside the operation area can be acquired according to the docking point and the boundary of the operation area. It should be noted that, the above-mentioned docking point, operation point, safe point, boundary of the operation area, obstacle, etc., include actual position information or map position information, which may be selected as desired, and are not limited herein.

The control device further includes a planning module for planning a first path between the docking point and the safe point and a second path between the safe point and the operation point according to the docking point information, the operation point information and the safe point information, so that the path between the docking point and the safe point passes through the safe point.

The planning module further plans a third path. A first auxiliary point on the first path is obtained, and the distance from the first auxiliary point to the safe point is less than or equal to the safe distance and less than or equal to the distance from the safe point to the operation point on the second path. An arc close to the safe point is planned as a third path by taking the first auxiliary point as a tangent point and taking the first path and the second path as tangents, so that the first path and the second path transit through the third path.

Through the control device, the autonomous path planning of the aircraft can be realized in real time after the information of the docking point, the operation point, and the safe point is obtained.

The application also provides a control equipment, which is arranged on the aircraft or the mobile terminal, including:

one or more processors;

a memory; and

one or more application programs, wherein the one or more application programs are stored in the memory and configured to be executed by the one or more processors, and the one or more programs are configured to execute the steps of the aircraft path planning method.

The control equipment can be arranged on the aircraft or the mobile terminal, and the path between the docking point and the operation point is planned by obtaining the information of the docking point, the operation point, and the safe point according to the above-mentioned method. The flight control device on the aircraft controls the aircraft to fly according to the planned path based on the planned path. It should be noted that the control equipment herein may be flight control equipment, or navigation equipment, which will not be limited herein.

The operation path planning method is described in detail below with reference to specific embodiments.

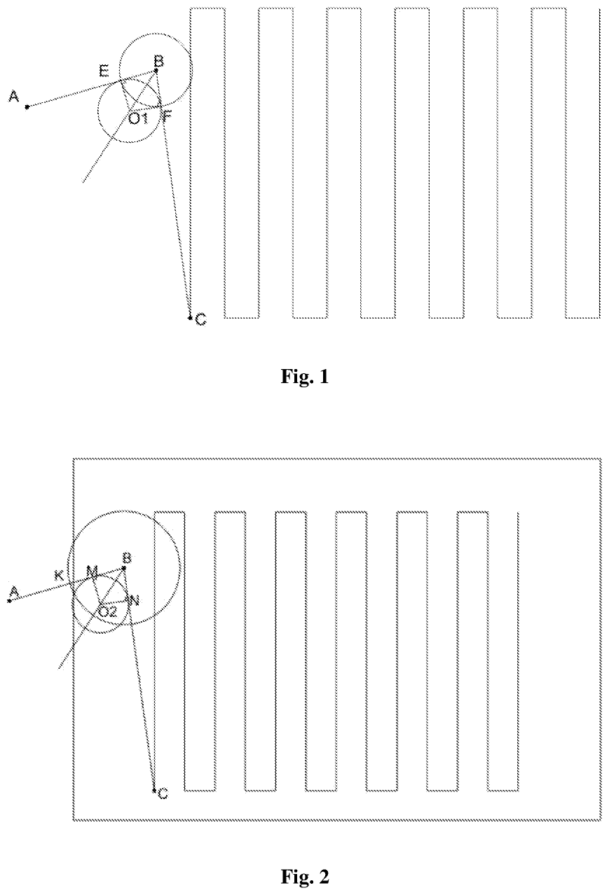

As shown in FIG. 1, which is a schematic diagram of a path planning method according to a first embodiment of the application, docking point A, operation point C, and safe point B are obtained, no obstacles existing within the safe distance around the safe point B. At the time, the docking point A, the operation point C and the safe point B can all be located in the operation area.

A first path AB between the docking point A and the safe point B is planned, and a second path BC between the safe point B and the operation point C is planned.

Obtaining a first auxiliary point E on the first path AB, wherein the distance from the safe point B to the docking point A is less than or equal to the safe distance. An arc close to the safe point B is planned as a third path [symbol] by taking the first auxiliary point E as a tangent point and taking the first path AB and the second path BC as tangents, the circle center of the arc being O1, wherein point F is a tangent point corresponding to the arc and the second path BC, namely a second auxiliary point, so that the first path and the second path smoothly transit through the arc. In this manner, a third path may be made near the safe point B to connect the first path AB and the second path BC such that the first path AB and the second path BC transit smoothly near B, and the third path does not encounter obstacles within the operation area, as shown by [symbol] .

Specifically, the aircraft can be an unmanned aerial vehicle. In the flight process, the unmanned aerial vehicle flies from the docking point A to the operation point C sequentially along the first path, the third path, and the second path to realize rapid flight. Specifically, when the unmanned aerial vehicle reaches the third path [symbol] , and when the aircraft flies along the third path [symbol] , the heading angle is changed in real time while the aircraft flies such that the heading of the aircraft is consistent with the tangential direction of the third path, and the heading is changed while the aircraft flies on the third path such that the heading is consistent with the tangential direction of the third path, and then the aircraft flies to the operation point. As such, the unmanned aerial vehicle does not need to stay anywhere on A [symbol] C while flying along the path A [symbol] C.

As shown in FIG. 2, a schematic diagram of a path planning method according to a second embodiment of the application is shown, where docking point A, operation point C and safe point B are obtained. The docking point A is located outside the operation area, the operation area is surrounded by several boundaries, and the safe point is located inside the operation area.

A first path AB between the docking point A and the safe point B is planned, and a second path BC between the safe point B and the operation point C is planned.

Optionally, safe point B is located in the operation area, where the distance between safe point B and any boundary of the operation area is greater than or equal to a preset threshold. At the time, the distance between the safe point B and any boundary is greater than or equal to a first threshold, the first threshold being 2.1 m, or the distance between the safe point B and the nearest boundary closest to the docking point A is greater than or equal to a second threshold, the second threshold being 3.2 m. The first path AB has no obstacles and can safely go through the operation boundary.

Optionally, obtaining a first auxiliary point M on the first path AB, wherein the distance from the safe point B to the docking point A is less than or equal to the safe distance. An arc close to the safe point B is planned as a third path [symbol] by taking the first auxiliary point M as a tangent point and taking the first path AB and the second path BC as tangents, the circle center of the arc being O2, wherein point N is a tangent point corresponding to the arc and the second path BC, namely a second auxiliary point, so that the first path and the second path smoothly transit through the arc. In this manner, a third path may be made near the safe point B to connect the first path AB and the second path BC such that the first path AB and the second path BC transit smoothly near B, and the third path does not encounter obstacles within the operation area, as shown by [symbol] . As such, the third path is inside the operation area, and the safety of operation flight is improved.

Specifically, in the flight process, the aircraft flies from the docking point A to the operation point C sequentially along the first path, the third path, and the second path to safely penetrate through the operation boundary and realize rapid flight. When the aircraft reaches the third path [symbol] , and when the aircraft flies along the third path [symbol] , the heading angle is changed in real time while the aircraft flies such that the heading of the aircraft is consistent with the tangential direction of the third path, and the heading is changed while the aircraft flies on the third path such that the heading is consistent with the tangential direction of the third path, and then the aircraft flies to the operation point. As such, the aircraft does not need to stay anywhere on path A [symbol] C while flying along the path A [symbol] C.

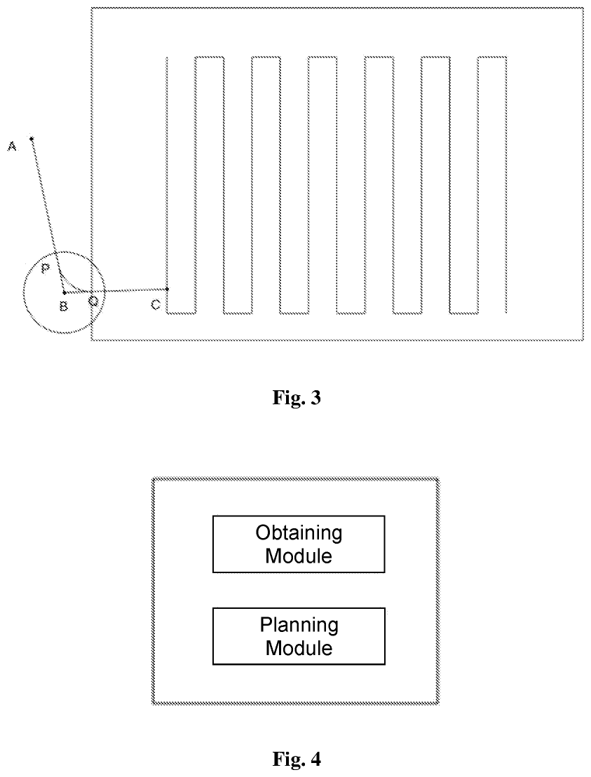

As shown in FIG. 3, a schematic diagram of a path planning method according to a third embodiment of the present application is shown. In this embodiment, the docking point A and the safe point B are located outside the operation area, and there is no obstacle within the safe distance around the safe point B.

A first path AB between the docking point A and the safe point B is planned, and a second path BC between the safe point B and the operation point C is planned. At this time, there is no obstacle on the second path so that the aircraft can safely go through the operation boundary.

Obtaining a first auxiliary point P on the first path AB, wherein the distance from the safe point B to the docking point A is less than or equal to the safe distance. An arc close to the safe point B is planned as a third path [symbol] by taking the first auxiliary point P as a tangent point and taking the first path AB and the second path BC as tangents, wherein point Q is a tangent point corresponding to the arc and the second path BC, namely a second auxiliary point, so that the first path and the second path smoothly transit through the arc. In this manner, a third path may be made near the safe point B to connect the first path AB and the second path BC such that the first path AB and the second path BC transit smoothly near B, and the third path does not encounter obstacles within the operation area, as shown by [symbol] .

Specifically, in the flight process, the aircraft flies from the docking point A to the operation point C along the first path, the third path, and the second path in sequence, and penetrates through the operation boundary along the second path to realize rapid flight. When the aircraft reaches the starting point P or Q of the third path [symbol] , and when the aircraft flies along the third path [symbol] , the heading angle is changed in real time while the aircraft flies such that the heading of the aircraft is consistent with the tangential direction of the third path, and the heading is changed while the aircraft flies on the third path such that the heading is consistent with the tangential direction of the third path, and then the aircraft flies to the operation point. As such, the aircraft does not need to stay anywhere on path A [symbol] C while flying along the path A [symbol] C.

The planning method of the third path is described in detail by Embodiment 2 below.

As shown in FIG. 2, in the embodiment, a second auxiliary point N can be determined first for the third path according to the distance from the safe point B to the first auxiliary point M, and the first auxiliary point M and the second auxiliary point N are taken as tangent points to plan an arc close to the safe point B as the third path; or concerning the third path, an angle bisector of AB and BC can be made by obtaining the safe point B, a circle with the radius r is made on the angle bisector to be tangent to AB and BC, and points where the circle is tangent to AB and BC are connected such that an arc is formed to serve as the third path.

In the embodiment, the distance from the safe point B to the first auxiliary point M on the first path AB is less than a preset threshold. Specifically, AB intersects with the operation boundary at K, M being the first auxiliary point that must be located between K and B to prevent the first auxiliary point M from touching the boundary, so MB=r/tan(θ/2) needs ≤KB, r≤KB*tan(θ/2). When KB=300 and θ=90°, r is any value less than or equal to 300, wherein r is the radius of the third path and θ is the angle between AB and BC.

Because the second path BC is in the operation area, N must be arranged between the safe point B and the operation point C, and the distance of BC on the second path is greater than or equal to the distance from the safe point to the second auxiliary point N, namely the distance of BN. Then BN=r/tan(θ/2), BC≥tan(θ/2). r≤BC*tan(θ/2). Assuming BC=1000 and θ=90°, then tan(θ/2)=1, BC≥tan(θ/2)=1000, and r can be any value less than or equal to 1000. The larger the BC, the freer the selection of r.

It should be noted that, for a convex operation area, BC is completely within the operation area and N is within the operation area regardless of the distance of points B or C from the operation boundary. For a concave operation area, whether the arc is within the operation area or not can be determined merely by verifying whether the triangular MBN is in the operation area or not. In practice, the verification applies to both convex and concave areas. By means of the path planning method provided by the application, a path for an aircraft to safely go through the operation boundary can be rapidly planned to avoid encountering possible obstacles.

Taking the third path [symbol] as an example, during a flight process, the unmanned aerial vehicle flies from the docking point A to the first auxiliary point M, the speed thereof accelerating from 0 to vx, and then decelerating to ω*r to M. The unmanned aerial vehicle reaches the second auxiliary point N at the angular speed of ω and linear speed of ω*r. The aircraft flies at speed ω*r from N point, and accelerates firstly and then decelerates to reach C. If NC is short, the speed of the unmanned aerial vehicle directly reduces to 0 from ω*r from point N to point C. In another embodiment, vx=ω*r, then the aircraft only needs to be accelerated from point A to point M, wherein w is the angular speed of the aircraft, and vx is a certain running speed.

When the arc radius r is smaller, the aircraft is closer to the safe point B. The smaller the flight speed of the unmanned aerial vehicle is, the longer the flight time is, the greater the influence of the blades on the operation target is, and the closer it is to the manner that the aircraft stays at the safe point B and turns. Therefore, the radius of the third path is r≥1 m. The range of the minimum value of r is not limited thereto, and may be r≥1.2 m, r≥1.5 m, r≥2 m, r≥3 m, r≥3.2 m, r≥3.5 m, etc., and may be set according to the parameter characteristics of the aircraft. Even if the docking point A and the safe point B are fixed, here, the docking point A is a take-off point, the take-off point and the operation area are unchanged, the radius r of the arc is unchanged, and the arc changes along with the change of the operation point C of each task, but the influence of the blade on the operation target can still be reduced.

In the case where ω and the distance of AB on the first path are fixed, the larger r is, the larger the distance of BM from the safe point B to the first auxiliary point M is, the smaller the distance AM from the docking point A to the first auxiliary point M is, and the larger ω*r is. At the time, the unmanned aerial vehicle needs to speed up to a larger ω*r within a short distance of AM. This requires that the acceleration time of the unmanned aerial vehicle to be short and the accelerated speed to be large. For example, v*v−0=2*a1*s1, v=ω*r, wherein s1 is the distance of AM between the docking point A and the first auxiliary point, i.e. the first speed limiting distance, a1 is the accelerated speed on the first path, and v is the running speed, s1=AB−r/tan(θ/2).

In order to prevent the acceleration time from being insufficient, the maximum accelerated speed a1 is limited as the maximum threshold for the known running accelerated speed, then v*v≤2*a1*s1.

In the case where the distance between the safe point B and the operation point C, i.e., the distance of BC, and ω are fixed, the larger r is, the larger the distance BN between the safe point B and the second auxiliary point N is, and the smaller the distance NC from the operation point C to the second auxiliary point N is. At the time, the unmanned aerial vehicle needs to decelerate from ω*r to 0 within a short distance of NC such that it is required that the deceleration time of the aircraft is short, and the absolute accelerated speed is large. For example, 0−v*v=−2*a2*s2, v=ω*r, wherein s2 is the distance between NC, namely the second speed limiting distance, and a2 is the accelerated speed on the second path, then s2=BC−r/tan(θ/2). In order to prevent the deceleration time from being insufficient, the maximum accelerated speed a2 is limited as the maximum threshold of the known running accelerated speed, v*v≤2*a2*s2.

a1 and a2 can be the same value or different values, and the user can set them as desired, which will not be limited herein.

In summary, the radius is r≥1 m. In order to prevent the influence of the blades on the operation target from being large because the flight speed is too small, a large enough radian is ensured for the aircraft to fly through the safe point, and the flight speed is ensured to be large enough such that the aircraft will not stay too long at the safe point. Radius to

$$r \leq \sqrt{\frac{2 a s}{{ω}^{2}}}$$

to ensure the time for acceleration or deceleration, wherein s can be s1 or s2 or a weighted average thereof and a can be a1 or a2 or a weighted average thereof. In the meantime, r≤KB*tan(θ/2) and BC*tan(θ/2) are enabled to ensure the safety of the third path and that the third path can be planned.

In the embodiment, several considerations should be made for the confirmation of the maximum value of the third path radius r:

1. r≤BC*tan(θ/2), ensuring that N is between B and C;

2. r≤KB*tan(θ/2), ensuring that M is between K and B;

3. r*r≤2*a1*s1/ω², ensuring that the aircraft has sufficient acceleration time; and

4. r*r≤2*a2*s2/ω², ensuring that the aircraft has sufficient deceleration time.

a1 and a2 can be the same or different. The greater the acceleration, the greater the pitch angle of the unmanned aerial vehicle to produce the accelerated speed, and therefore the greater the force produced by the propeller, the faster the rotating speed required for the motor. This can affect motor and energy requirements in a short period of time. Therefore, the maximum threshold of accelerated speed is limited to ensure efficient and energy-saving safe operation.

The minimum value of the above-mentioned several conditions can be selected to define the maximum value of the third path radius r so as to select a radius, or the radius r satisfying each of the above-mentioned conditions can be selected, which will not be limited herein. A user can set the radius according to operation requirements as long as the above-mentioned conditions are satisfied at the same time.

According to the path planning method of the application, the safe running path is determined according to the docking point, the safe point, and the operation point, and a new route connecting the docking point and the safe point and connecting the safe point and the operation point is planned near the safe point such that the aircraft does not stay in the path from the docking point to the operation point, the flight speed can be kept at ω*r or more when the heading is changed, and the flight speed of the aircraft is improved. The flight efficiency is improved, and meanwhile, the aircraft is prevented from staying at the safe point which causes damage to the operation target.

It is to be noted that the operation point C can be the first operation point of the operation task or any operation point on the operation task route. When the unmanned aerial vehicle takes off, the path is planned in real time according to the docking point A, the safe point B and the operation point C. A completely autonomous route for safely entering or leaving the operation area can be realized corresponding to each take-off and landing and sudden take-off and landing in the operation task.

In addition, the path planning can correspond to the safe take-off or safe landing of an aircraft. The aircraft plans a path in real time according to the current flight track. When the aircraft takes off safely, the docking point is the take-off point, and at the time, the unmanned aerial vehicle reaches the operation point through the safe point along the first path, the third path, and the second path from the take-off point; when the aircraft is safely landed, the docking point is the landing point, and at the time, the unmanned aerial vehicle reaches the landing point from the operation point along the second path, the third path, and the first path through the safe point such that the safe and rapid flight effect is realized. At the time, the passing safe point does not actually mean passing through the safe point, but means passing through the nearby position of the safe point.

It needs to be explained that in practical application, after the docking point A and the operation area boundary, the docking point A and the safe distance, or the docking point A, the operation point C and the safe distance are determined, the position of the safe point B can be determined. Then according to the setting of the arc radius r, the path of rapidly entering the operation area can be planned in real time according to requirements without needing manual interference such that the completely autonomous safe and rapid flight operation is realized.

According to the application, the operation path is planned through the safe point and on the basis of the safe point such that the safe and rapid entering and exiting the operation boundary is realized, the flight operation of the aircraft is more efficient and more automatic, and no damage will be caused to the operation target, thereby ensuring the growth environment of the operation target.

1. An aircraft operation path planning method, comprising:
obtaining a docking point, an operation point, and a safe point, wherein no obstacle exists within a safe distance range of the safe point; and
planning a first path between the docking point and the safe point, and a second path between the safe point and the operation point, so that a path between the docking point and the operation point passes through the safe point in a smooth transition manner.

2. The aircraft operation path planning method according to claim 1, further comprising:
obtaining a first auxiliary point on the first path, wherein a distance from the first auxiliary point to the safe point is less than or equal to the safe distance and less than or equal to the distance from the safe point to the operation point on the second path, and planning an arc close to the safe point as a third path by taking the first auxiliary point as a tangent point and taking the first path and the second path as tangents, so that the first path and the second path transit through the third path.

3. The aircraft operation path planning method according to claim 2, wherein the docking point is located outside an operation area, the safe point is located inside the operation area, the operation area is surrounded by several boundaries, and a distance from the first auxiliary point to the safe point is less than or equal to a distance from the safe point to a point where the first path intersects with the boundary.

4. The aircraft operation path planning method according to claim 2, wherein the third path is obtained in at least two ways below:
obtaining a second auxiliary point on the second path, wherein the distance from the second auxiliary point to the safe point is the distance from the first auxiliary point to the safe point, and planning an arc close to the safe point as the third path by taking the first auxiliary point and the second auxiliary point as tangent points; or
obtaining an angle bisector of the first path and the second path, obtaining a circle center which is an intersection point of a vertical line taking the first auxiliary point on the first path as a foot and the angle bisector, and planning an arc close to the safe point as the third path by using the circle center and taking a vertical distance from the circle center to the first auxiliary point as a radius.

5. The aircraft operation path planning method according to claim 2, wherein a radius of the third path is r=s*tan(θ/2), wherein s is a distance from the first auxiliary point to the safe point on the first path, θ is an included angle between the first path and the second path, and the radius of the third path is r≥1 m.

6. The aircraft operation path planning method according to claim 2, obtaining a distance from the docking point to the first auxiliary point on the first path as a first speed limiting distance, and obtaining a distance from the operation point on the second path to a tangent point of the third path and the second path as a second speed limiting distance, wherein the first speed limiting distance and the second speed limiting distance are greater than or equal to
$$\frac{{w}^{2} {r}^{2}}{2 a} ,$$
wherein ω is an angular speed known to travel through the third path, a is a maximum threshold of known travelling accelerated speed, and r is the radius of the third path.

7. The aircraft operation path planning method according to claim 1, wherein the docking point is a take-off point or a landing point.

8. The aircraft operation path planning method according to claim 1, wherein the operation point comprises any point in an operation task path.

9. A control device, comprising:
an obtaining module for obtaining a docking point, an operation point, and a safe point, wherein no obstacle exists within a safe distance range of the safe point; and
a planning module for planning a first path between the docking point and the safe point and a second path between the safe point and the operation point, so that a path between the docking point and the safe point passes through the safe point in a smooth transition manner.

10. The control device according to claim 9, comprising: the planning module also obtaining a first auxiliary point on the first path, wherein a distance from the first auxiliary point to the safe point is less than or equal to the safe distance and less than or equal to the distance from the safe point to the operation point on the second path, and planning an arc close to the safe point as a third path by taking the first auxiliary point as a tangent point and taking the first path and the second path as tangents, so that the first path and the second path transit through the third path.

11. A control equipment, arranged on an aircraft or a mobile terminal, wherein the control equipment comprises:
one or more processors;
a memory; and
one or more application programs, wherein the one or more application programs are stored in the memory and configured to be executed by the one or more processors, and the one or more programs are configured to execute steps for executing the aircraft path planning method according to claim 1.
